(19) United States
(12) Patent Application Publication
(10) Pub. No.: US 2025/0279562 A1
(43) Pub. Date: Sep. 4, 2025

(54) ELECTRICAL ENERGY STORAGE DEVICE

(71) Applicant: Prime Planet Energy & Solutions, Inc., Tokyo (JP)

(72) Inventor: Taisuke ISEDA, Kobe-shi (JP)

(21) Appl. No.: 19/061,916

(22) Filed: Feb. 24, 2025

(30) Foreign Application Priority Data
Mar. 1, 2024 (JP) 2024-031737

(51) Int. Cl. H01M 50/627; H01G 11/58; H01G 11/78; H01M 10/0587; H01M 50/103; H01M 50/534; H01M 50/538

(52) U.S. Cl. CPC H01M 50/627; H01G 11/78; H01M 10/0587; H01M 50/103; H01M 50/534; H01M 50/538; H01G 11/58

(57) ABSTRACT

An electrical energy storage device disclosed herein includes a square case having a pair of third surfaces, an electrode body including a positive electrode and a negative electrode, a positive electrode tab that is provided in the positive electrode, a negative electrode tab that is provided in the negative electrode, an electrolyte solution, and a liquid injection hole that is provided at the third surface of the case and at a position closer to the negative electrode tab than to the positive electrode tab.

### CROSS REFERENCE TO RELATED APPLICATION

This application claims the benefit of priority to Japanese Patent Application No. 2024-031737 filed on Mar. 1, 2024. The entire contents of this application are hereby incorporated herein by reference.

### BACKGROUND OF THE DISCLOSURE

### 1. Field

The present disclosure relates to an electrical energy storage device.

### 2. Background

Conventionally, an electrical energy storage device including an electrode body, an electrolyte solution, and a case that accommodates the electrode body and the electrolyte solution has been known. References of the conventional art related to the liquid injection of the electrolyte solution in such an electrical energy storage device include Japanese Patent No. 4009802 and Japanese Patent Application Publication No. 2004-247120. Japanese Patent No. 4537353, for example, discloses a laminate battery including an electrode body, which includes a positive electrode and a negative electrode, an electrolyte solution, and a case that accommodate the electrode body and the electrolyte solution. This laminate battery further includes a positive electrode tab extending from the positive electrode and a negative electrode tab extending from the negative electrode, which are disposed inside the case, and includes a liquid injection hole at an intermediate position of the case between the positive electrode tab and the negative electrode tab.

### SUMMARY

According to the present inventor's examination, however, the positive electrode tab is often softer and deformable more easily than the negative electrode tab in general. Therefore, when the liquid injection hole is provided near the positive electrode tab, the positive electrode tab may be damaged with the force applied when the electrolyte solution is injected. In particular, a high-capacity or large-sized battery, which is employed as an on-vehicle battery, for example, uses a large amount of electrolyte solution; therefore, a large amount of electrolyte solution may be injected at one time through the liquid injection hole and the problem as described above can occur.

The present disclosure has been made in view of the above circumstances, and an object is to provide an electrical energy storage device in which damage of a positive electrode tab at injection of an electrolyte solution is suppressed.

An electrical energy storage device according to the present disclosure includes: a square case that includes a first surface with a substantially rectangular shape having a pair of short sides and a pair of long sides, a pair of second surfaces extending from the pair of short sides, and a pair of third surfaces extending from the pair of long sides and having a larger area than the first surface and the second surfaces; an electrode body that is accommodated inside the case and includes a positive electrode and a negative electrode; a positive electrode tab that is provided in the positive electrode; a negative electrode tab that is provided in the negative electrode; an electrolyte solution that is accommodated inside the case; and a liquid injection hole that is provided at the third surface of the case and at a position closer to the negative electrode tab than to the positive electrode tab.

According to the present disclosure, by providing the liquid injection hole at the position closer to the negative electrode tab than to the positive electrode tab, damage of the positive electrode tab at the liquid injection of the electrolyte solution can be reduced relatively.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating an electrical energy storage device according to an embodiment;

FIG. 2 is a schematic longitudinal cross-sectional view taken along line II-II in FIG. 1;

FIG. 3 is a schematic lateral cross-sectional view taken along line III-III in FIG. 1;

FIG. 4 is a partial enlarged view schematically illustrating a vicinity of a negative electrode tab at liquid injection;

FIG. 5 is a diagram corresponding to FIG. 2 according to a first modification; and

FIG. 6 is a diagram corresponding to FIG. 1 according to a second modification.

### DETAILED DESCRIPTION OF THE PREFERRED EMBODIMENTS

Hereinafter, preferred embodiments of the art disclosed herein will be described with reference to the drawings as appropriate. Matters that are other than matters particularly mentioned in the present specification and that are necessary for the implementation of the art disclosed herein (for example, the general configuration and manufacturing process of an electrical energy storage device that do not characterize the art disclosed herein) can be grasped as design matters of those skilled in the art based on the prior art in the relevant field. The art disclosed herein can be implemented on the basis of the disclosure of the present specification and common technical knowledge in the relevant field. Note that in the drawings below, the members and parts with the same operation are denoted by the same reference signs and the overlapping description may be omitted or simplified. Moreover, in the present specification, the notation “A to B” for a range signifies a value more than or equal to A and less than or equal to B, and is meant to encompass also the meaning of being “more than A” and “less than B”.

### [Electrical Energy Storage Device]

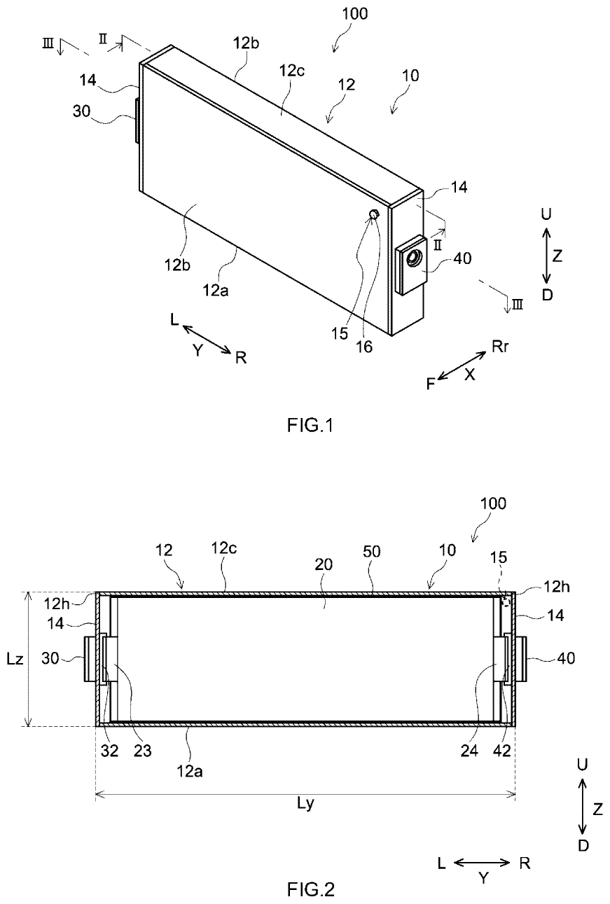

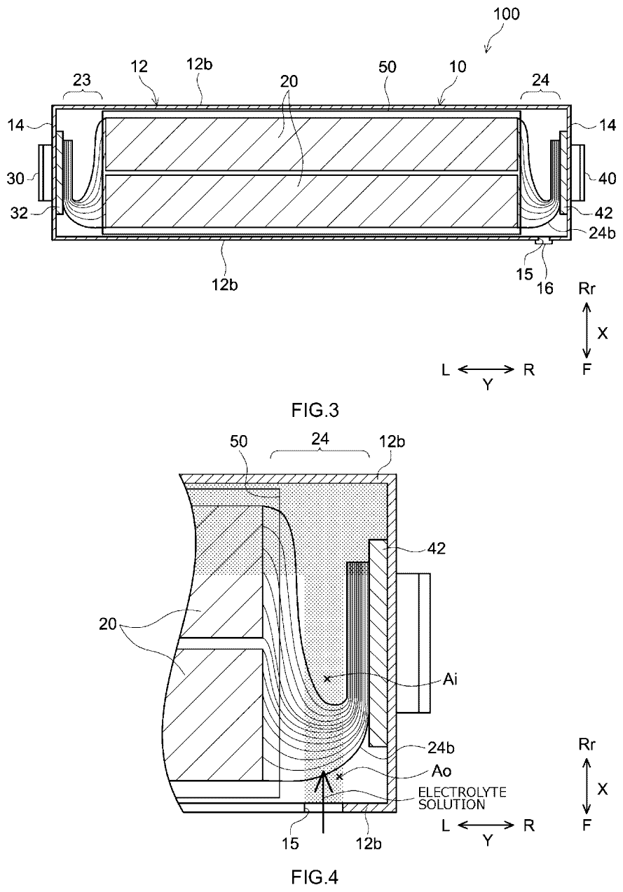

FIG. 1 is a perspective view schematically illustrating an electrical energy storage device 100 according to an embodiment. FIG. 2 is a schematic longitudinal cross-sectional view taken along line II-II in FIG. 1. FIG. 3 is a schematic lateral cross-sectional view taken along line III-III in FIG. 1. As illustrated in FIG. 1, the electrical energy storage device 100 has a square shape including a hexahedron (specifically, rectangular parallelepiped shape) here. In addition, in the description below, reference signs F, Rr, L, R, U, and D in the drawings respectively denote front, rear, left, right, up, and down, and reference signs X, Y, and Z in the drawings respectively denote a thickness direction of the electrical energy storage device 100, a width direction that is orthogonal to the thickness direction, and an up-down direction that is orthogonal to the thickness direction and the width direction. The up-down direction Z is typically a direction that coincides with a vertical direction. However, these are merely directions for convenience of description and do not limit the mode of installation of the electrical energy storage device 100.

As illustrated in FIG. 2, the electrical energy storage device 100 includes a case 10, an electrode body 20, an electrolyte solution (not illustrated), a positive electrode terminal 30, a negative electrode terminal 40, and a liquid injection hole 15 (also see FIG. 1). The electrical energy storage device 100 is a nonaqueous electrolyte solution secondary battery here, and is a lithium ion secondary battery, for example. The electrical energy storage device 100 is configured in such a way that the electrode body 20 and the electrolyte solution are accommodated in the case 10 where the positive electrode terminal 30 and the negative electrode terminal 40 are attached and the liquid injection hole 15 is provided. Note that in the present specification, the term “electrical energy storage device” refers to general devices that are capable of being charged and discharged repeatedly, and corresponds to a concept encompassing secondary batteries such as lithium ion secondary batteries and nickel-hydrogen batteries and capacitors such as lithium ion capacitors and electrical double-layer capacitors.

The case 10 is a housing that accommodates the electrode body 20 and the electrolyte solution. As illustrated in FIG. 1, the case 10 has an outer shape having a flat and bottomed square shape (specifically, rectangular parallelepiped shape) here. The material of the case 10 may be the same as a material that has been used conventionally, and is not particularly limited. The case 10 is preferably made of metal and is more preferably formed of, for example, iron, an iron alloy such as stainless steel, aluminum, an aluminum alloy, or the like. The case 10 is preferably made of a metal plate.

As illustrated in FIG. 2, here, the case 10 includes a case main body 12 with a square tubular shape having a pair of opening parts 12h at both end parts in the width direction Y, and two sealing plates 14 that close the pair of opening parts 12h of the case main body 12. The case 10 is integrated in such a way that the sealing plates 14 are bonded (for example, bonded by welding) to peripheries of the pair of opening parts 12h of the case main body 12. The case 10 is hermetically sealed (closed).

As illustrated in FIG. 1, the case main body 12 includes a bottom surface 12a (first surface) with an approximately rectangular shape having a pair of short sides and a pair of long sides, a pair of long side surfaces 12b (third surfaces) extending from the pair of long sides of the bottom surface 12a and facing each other, and a top surface 12c (fourth surface) facing the bottom surface 12a. The case main body 12 is formed by, for example, bending one metal plate into a square tubular shape and bonding (for example, bonding by welding) the joint. In this embodiment, the bottom surface 12a is one example of “the first surface”, and the long side surface 12b is one example of “the third surface”.

The long side surface 12b (third surface) is larger in area than the bottom surface 12a (first surface) and the sealing plate 14 (second surface). The long side surface 12b includes the liquid injection hole 15. Note that the liquid injection hole 15 will be described below. The top surface 12c (fourth surface) has the same shape and area as the bottom surface 12a. Therefore, the long side surface 12b is larger in area than the top surface 12c. The top surface 12c extends from each long side of the pair of long side surfaces 12b and connects between upper end parts of the pair of long side surfaces 12b.

Note that in the present specification, the term “substantially rectangular shape” encompasses, in addition to a perfect rectangular shape (rectangle), for example, a shape whose corner connecting a long side and a short side of the rectangular shape is rounded, a shape whose corner includes a notch, and the like.

The pair of sealing plates 14 are plate-shaped members that seal the pair of opening parts 12h. The sealing plate 14 has a substantially rectangular shape in a plan view. The sealing plates 14 extend from the pair of short sides of the bottom surface 12a and face each other. One of the pair of sealing plates 14 includes the positive electrode terminal 30 and the other includes the negative electrode terminal 40. Note that the positive electrode terminal 30 and the negative electrode terminal 40 will be described below. In this embodiment, the sealing plate 14 is one example of “the second surface”.

The size of the case 10 can be changed as appropriate in accordance with the size of the electrode body 20 or the like, for example. Therefore, although not limited in particular, as illustrated in FIG. 2, for example, a width (length in the width direction Y) Ly of the case 10 is preferably 20 cm or more, and more preferably 25 cm or more. The width Ly may be 35 cm or less, or 30 cm or less. In addition, a height (length in the up-down direction Z) Lz of the case 10 is preferably 5 cm or more, and more preferably 8 cm or more. The height Lz may be 12 cm or less, or 10 cm or less. A large battery in which the case 10 has the width Ly or height Lz that is more than or equal to a predetermined value also uses a large amount of electrolyte solution. Therefore, it is particularly effective to apply the art disclosed herein.

Although there is no particular limitation, the internal capacity of the case 10 (the spatial capacity of the entire case 10 obtained by (length in thickness direction X)×(length Ly in width direction Y)×(length Lz in up-down direction Z)) is preferably 500 cm³ or more, and more preferably 1000 cm³ or more. The upper limit of the internal capacity of the case 10 may be 3000 cm³ or less, or 1500 cm³ or less. A large battery in which the case 10 has the internal capacity that is more than or equal to a predetermined value also uses a large amount of electrolyte solution. Therefore, it is particularly effective to apply the art disclosed herein. The art disclosed herein, however, is also applicable to a small battery whose internal capacity is 300 cm³ or less (typically, 150 cm³ or less).

The electrode body 20 is accommodated inside the case 10 as illustrated in FIG. 2. Although not illustrated, the electrode body 20 includes a positive electrode and a negative electrode. The structure of the electrode body 20 may be similar to the conventional one without particular limitations. The positive electrode typically includes a positive electrode current collector and a positive electrode active material layer fixed to the positive electrode current collector. The negative electrode typically includes a negative electrode current collector and a negative electrode active material layer fixed to the negative electrode current collector. The electrode body 20 is accommodated inside the case 10 while being covered with an insulating sheet (electrode body holder) 50 made of resin here.

As illustrated in FIG. 3, here, two (a plurality of) electrode bodies 20 are accommodated inside one case 10. The two electrode bodies 20 are disposed side by side along the thickness direction X. However, the number of electrode bodies 20 to be accommodated inside one case 10 is not limited in particular and may be one, or three or more in another embodiment.

The electrode body 20 is here a wound electrode body in which the positive electrode with a band shape and the negative electrode with a band shape are stacked through a separator with a band shape and wound in a longitudinal direction using a winding axis as a center. In this embodiment, the electrode body 20 is disposed inside the case 10 with the winding axis substantially parallel to the width direction Y. However, in another embodiment, the electrode body 20 may be disposed inside the case 10 with the winding axis substantially parallel to the up-down direction Z, for example. In another embodiment, the electrode body 20 may be a multilayer electrode body in which a plurality of square (typically, rectangular) positive electrodes and a plurality of square (typically, rectangular) negative electrodes are stacked in an insulated state.

As illustrated in FIG. 2 and FIG. 3, a positive electrode tab 23 is provided in the positive electrode of the electrode body 20. The positive electrode tab 23 is preferably made of metal and is more preferably formed of aluminum or an aluminum alloy. The positive electrode tab 23 is preferably formed of the same kind of metal as the positive electrode terminal 30. The positive electrode tab 23 is a part of the positive electrode current collector here. The positive electrode tab 23 has a convex shape here, and protrudes from the electrode body 20 to one side in the width direction Y (to the left side in FIG. 2 and FIG. 3). The positive electrode tab 23 protrudes toward the first sealing plate 14 (the left sealing plate 14 in FIG. 2 and FIG. 3, one second surface) here. The positive electrode tab 23 is electrically connected to the positive electrode terminal 30 directly or indirectly. The positive electrode tab 23 is electrically connected to the positive electrode terminal 30 through a positive electrode current collecting part 32 here.

In the negative electrode of the electrode body 20, a negative electrode tab 24 is provided. The negative electrode tab 24 is preferably made of metal and is more preferably formed of copper or a copper alloy. The negative electrode tab 24 is preferably formed of the same kind of metal as the negative electrode terminal 40. The negative electrode tab 24 is a part of the negative electrode current collector here. The negative electrode tab 24 has a convex shape here, and protrudes from the electrode body 20 to the other side in the width direction Y (to the right side in FIG. 2 and FIG. 3). The negative electrode tab 24 protrudes toward the second sealing plate 14 (the right sealing plate 14 in FIG. 2 and FIG. 3, the other second surface) here. The negative electrode tab 24 is electrically connected to the negative electrode terminal 40 directly or indirectly. The negative electrode tab 24 is electrically connected to the negative electrode terminal 40 through a negative electrode current collecting part 42 here.

As illustrated in FIG. 3, the negative electrode tabs 24 of the two electrode bodies 20 are attached to the negative electrode current collecting part 42 in a bent or curved state. Specifically, the negative electrode tab 24 of the electrode body 20 that exists on a front side in the thickness direction X is folded into an L-like shape in a plan view. The negative electrode tab 24 of the electrode body 20 that exists on a rear side in the thickness direction X is folded into a U-like shape in the plan view. The negative electrode tab 24 of the electrode body 20 that exists on the rear side in the thickness direction X includes a curved part 24b that is curved from the first long side surface 12b (the long side surface 12b on the rear side in FIG. 3, one third surface) toward the second long side surface 12b (the long side surface 12b on the front side in FIG. 3, the other third surface).

The electrolyte solution is accommodated inside the case 10 together with the electrode body 20. The electrolyte solution may be similar to the conventional one without particular limitations. The electrolyte solution is typically a nonaqueous electrolyte solution containing a nonaqueous solvent and a supporting salt (electrolyte salt, for example Li salt or Na salt). The electrolyte solution is typically in a liquid form but may alternatively be in a gel form. Although there is no particular limitation, the amount of electrolyte solution included in one case 10 in the electrical energy storage device 100 for the use on a vehicle or the like can be, for example, 100 g or more, 200 g or more, or even 300 g or more. When the amount of electrolyte solution is large in this manner, the liquid injecting speed at the liquid injection of the electrolyte solution may be increased from the viewpoint of productivity. Therefore, it is demanded to prevent the damage of the positive electrode tab at the liquid injection and it is particularly effective to apply the art disclosed herein.

The positive electrode terminal 30 is provided at the first sealing plate 14 (the left sealing plate 14 in FIG. 2 and FIG. 3, one second surface). The positive electrode terminal 30 is preferably made of metal, and is more preferably formed of aluminum or an aluminum alloy, for example. As illustrated in FIG. 2 and FIG. 3, the positive electrode terminal 30 is electrically connected to the positive electrode tab 23 through the positive electrode current collecting part 32 inside the case 10.

The negative electrode terminal 40 is provided at the second sealing plate 14 (the right sealing plate 14 in FIG. 2 and FIG. 3, the other second surface). The negative electrode terminal 40 is provided on a surface of the case 10 on a side opposite to the positive electrode terminal 30. The negative electrode terminal 40 is preferably made of metal and is more preferably formed of copper or a copper alloy, for example. As illustrated in FIG. 2 and FIG. 3, the negative electrode terminal 40 is electrically connected to the negative electrode tab 24 through the negative electrode current collecting part 42 inside the case 10.

Note that in this embodiment, the positive electrode terminal 30 and the negative electrode terminal 40 are provided at the pair of sealing plates 14; however, in another embodiment, the positive electrode terminal 30 and the negative electrode terminal 40 may be provided at the same sealing plate 14 or may be provided at the case main body 12.

The liquid injection hole 15 is to inject the electrolyte solution into the case 10 after the sealing plates 14 are assembled to the case main body 12. The liquid injection hole 15 is sealed with a sealing member 16 after the electrolyte solution is injected. A conventionally known member can be used as the sealing member 16 without particular limitations. Examples of the sealing member 16 include a metal member such as a blind rivet.

The liquid injection hole 15 is provided at the second long side surface 12b of the case 10 (the long side surface 12b on the front side in FIG. 1 and FIG. 3, the other third surface) here. Note that in FIG. 2, the position of the liquid injection hole 15 is expressed virtually with an imaginary line. As illustrated in FIG. 3, the liquid injection hole 15 is a penetration hole that penetrates the long side surface 12b in the thickness direction X.

In the art disclosed herein, the liquid injection hole 15 is provided at a position closer to the negative electrode tab 24 than to the positive electrode tab 23. This arrangement makes it difficult for the electrolyte solution to be in contact with the positive electrode tab 23 when the electrolyte solution is injected, so that the damage of the positive electrode tab 23 can be reduced relatively. In addition, at the liquid injection of the electrolyte solution, the liquid injecting speed can be increased to, for example, 500 g/min or more; therefore, even large batteries can be produced efficiently.

As illustrated in FIG. 2, in the up-down direction Z, the liquid injection hole 15 is preferably provided over the negative electrode tab 24 in the vertical direction. This arrangement makes it possible to inject the electrolyte solution efficiently and impregnate the electrode body 20. It is preferable that the electrode body 20 do not exist right under the liquid injection hole 15 (at a position overlapping in the plan view). Thus, the electrolyte solution is not easily in contact with the electrode body 20 when the electrolyte solution is injected, so that the damage of the electrode body 20, for example the detachment of the separator can be reduced relatively. In addition, at the liquid injection of the electrolyte solution, the liquid injecting speed can be increased; therefore, even large batteries can be produced efficiently. Moreover, a straightening plate (so-called baffle plate) that restricts so as to make it difficult for the electrolyte solution to be in contact with the electrode body 20 becomes unnecessary; thus, the number of components can be reduced and additionally, the usable region out of the internal capacity of the case 10 can be increased.

As illustrated in FIG. 2 and FIG. 3, the liquid injection hole 15 is preferably provided between the second sealing plate 14 (right sealing plate 14 in FIG. 2 and FIG. 3, the other second surface) and an end part of the electrode body 20 in the width direction Y (direction where the negative electrode tab 24 protrudes). In other words, in the width direction Y, the liquid injection hole 15 is preferably provided in a region where the curved part 24b of the negative electrode tab 24 is disposed. This arrangement makes it difficult for the electrolyte solution to be in contact with the electrode body 20 when the electrolyte solution is injected, so that the damage of the electrode body 20, for example the detachment of the separator can be reduced relatively. In addition, at the liquid injection of the electrolyte solution, the liquid injecting speed can be increased; therefore, even large batteries can be produced efficiently. Moreover, a straightening plate (so-called baffle plate) that restricts so as to make it difficult for the electrolyte solution to be in contact with the electrode body 20 becomes unnecessary; thus, the number of components can be reduced and additionally, the usable region out of the internal capacity of the case 10 can be increased.

As illustrated in FIG. 3, in the thickness direction X, the liquid injection hole 15 preferably faces directly the first long side surface 12b (the long side surface 12b on the rear side in FIG. 3, one third surface). FIG. 4 is a partial enlarged view schematically illustrating a vicinity of the negative electrode tab 24 at the liquid injection. At the liquid injection of the electrolyte solution, the electrolyte solution flows into the case 10 through the liquid injection hole 15 as indicated by an arrow in FIG. 4. At this time, when the liquid injection hole 15 faces the long side surface 12b, the injected electrolyte solution is brought into contact with the long side surface 12b that faces the liquid injection hole 15 and typically, the electrolyte solution shifts downward along an inner wall surface of the long side surface 12b. Therefore, even if the liquid injecting speed is high, the force of liquid injection can be relieved. Thus, the liquid injecting speed can be increased and even large batteries can be produced efficiently. In addition, the electrolyte solution is not easily in direct contact with the negative electrode tab 24 and the damage of the negative electrode tab 24 is suppressed.

As illustrated in FIG. 3, when the negative electrode tab 24 includes the curved part 24b that is curved from the first long side surface 12b (the long side surface 12b on the rear side in FIG. 3, one third surface) toward the second long side surface 12b (the long side surface 12b on the front side in FIG. 3, the other third surface), the liquid injection hole 15 is preferably provided at the second long side surface 12b (the other third surface). In other words, the liquid injection hole 15 is preferably provided to face a side where the curved part 24b protrudes (apex side).

When the liquid injection hole 15 is provided so as to face the apex side of the curved part 24b as illustrated in FIG. 4, the electrolyte solution that enters from the liquid injection hole 15 is in contact with an outer peripheral side (back surface side) Ao of the curved part 24b and tends to shift along an outer peripheral surface of the curved part 24b. Therefore, for example, compared to a case in which the electrolyte solution that enters from the liquid injection hole 15 is in contact with an inner peripheral side (ventral side) Ai of the curved part 24b, the force of the liquid injection does not easily energize the negative electrode tab 24 relatively. Accordingly, bending or moving of the negative electrode tab 24 due to the force at the liquid injection can be suppressed.

Note that the case 10 may further include an exhaust hole for degassing when the electrolyte solution is injected. For example, the exhaust hole may be provided at the first long side surface 12b (the long side surface 12b on the rear side in FIG. 1 and FIG. 3, one third surface) of the case 10, may be provided at the second long side surface 12b (the long side surface 12b on the front side in FIG. 1 and FIG. 3, the other third surface) of the case 10, or may be provided at the sealing plate 14 (the second surface of the case 10) or the top surface 12c (the fourth surface of the case 10). The exhaust hole is a second penetration hole that penetrates the long side surface 12b in the thickness direction X. The exhaust hole is preferably provided at a position closer to the positive electrode tab 23 than to the negative electrode tab 24, which is contrary to the liquid injection hole 15. Thus, a large amount of electrolyte solution can be smoothly injected. In addition, the impregnation of the electrode body 20 with the electrolyte solution can be promoted. Note that the exhaust hole is preferably sealed with the sealing member after the electrolyte solution is injected, which is similar to the liquid injection hole 15.

### [Application of Electrical Energy Storage Device]

The electrical energy storage device 100 can be used in various applications, and for example, suitably used as a motive power source (electrical power source for driving) for a motor mounted on a vehicle such as a passenger car or a truck. Although the type of vehicles is not particularly limited, examples thereof may include a plug-in hybrid electric vehicle (PHEV), a hybrid electric vehicle (HEV), a battery electric vehicle (BEV), and the like.

Although the preferable embodiments of the present disclosure have been described above, they are merely examples. The present disclosure can be implemented in various other modes. The present disclosure can be implemented based on the contents disclosed in the present specification and the technical common sense in the relevant field. The techniques described in the scope of claims include those in which the embodiments exemplified above are variously modified and changed. For example, another modification can replace a part of the aforementioned embodiment or be added to the aforementioned embodiment. Additionally, the technical feature may be deleted as appropriate unless such a feature is described as an essential element.

For example, in the electrode body 20 in FIG. 2 and FIG. 3 described above, the positive electrode tab 23 protrudes toward the first sealing plate 14 (the left sealing plate 14 in FIG. 2 and FIG. 3, one second surface) and the negative electrode tab 24 protrudes toward the second sealing plate 14 (the right sealing plate 14 in FIG. 2 and FIG. 3, the other second surface). In addition, the positive electrode terminal 30 is provided at the first sealing plate 14 (the left sealing plate 14 in FIG. 2 and FIG. 3, one second surface) and the negative electrode terminal 40 is provided at the second sealing plate 14 (the right sealing plate 14 in FIG. 2 and FIG. 3, the other second surface). However, the present disclosure is not limited to this example.

FIG. 5 is a diagram corresponding to FIG. 2 according to a first modification. An electrical energy storage device 200 illustrated in FIG. 5 may be similar to the electrical energy storage device 100 except that the electrical energy storage device 200 includes an electrode body 120, a positive electrode terminal 130, and a negative electrode terminal 140. In the electrode body 120, both a positive electrode tab 123 and a negative electrode tab 124 protrude toward the first sealing plate 14 (the right sealing plate 14 in FIG. 5, one second surface). In addition, the positive electrode terminal 130 and the negative electrode terminal 140 are provided at the same sealing plate 14, specifically the first sealing plate 14 (the right sealing plate 14 in FIG. 5, one second surface). In this modification, the liquid injection hole 15 is preferably provided between the first sealing plate 14 (the left sealing plate 14 in FIG. 5, one second surface) and an end part of the electrode body 120 in the width direction Y (direction where the positive electrode tab 123 and the negative electrode tab 124 protrude) on a side opposite to the positive electrode tab 123 with the negative electrode tab 124 held therebetween. In the electrical energy storage device 200, it is also possible to apply the art disclosed herein suitably.

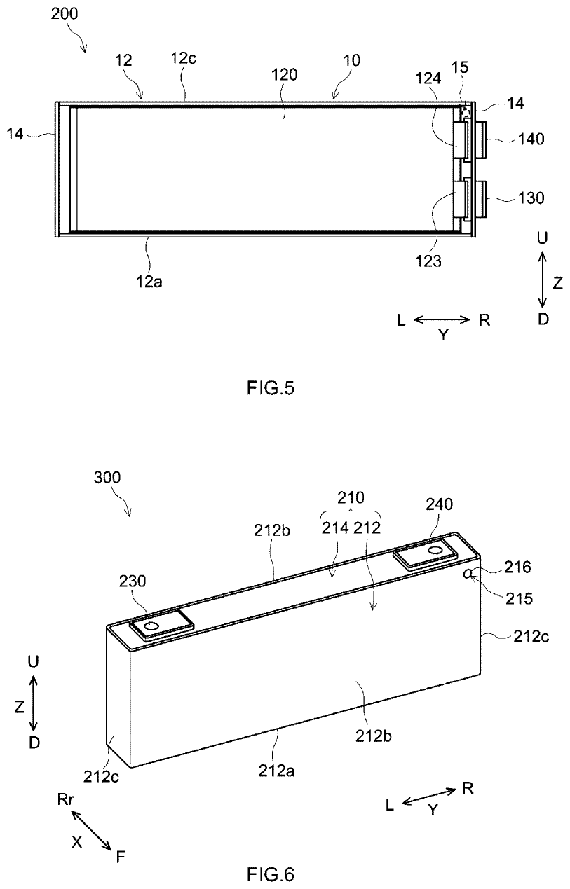

For example, in the electrical energy storage device 100 in FIG. 1 and the electrical energy storage device 200 in FIG. 5, the positive electrode terminals 30 and 130 and the negative electrode terminals 40 and 140 are provided at the end part in the width direction Y. However, the present disclosure is not limited to this example. FIG. 6 is a diagram corresponding to FIG. 1 according to a second modification. An electrical energy storage device 300 illustrated in FIG. 6 may be similar to the electrical energy storage device 100 or the electrical energy storage device 200 except that the electrical energy storage device 300 includes a case 210, a positive electrode terminal 230, and a negative electrode terminal 240.

As illustrated in FIG. 6, the case 210 includes a case main body 212 with a bottomed square shape (box shape) having an opening at one surface (here, upper surface), and a sealing plate 214 that closes the opening of the case main body 212. The case main body 212 includes a first surface 212a with a substantially rectangular shape having a pair of short sides and a pair of long sides, a pair of second surfaces 212c extending from the pair of short sides of the first surface 212a and facing each other, and a pair of third surfaces 212b extending from the pair of long sides of the first surface 212a and facing each other. The third surface 212b includes a liquid injection hole 215. The liquid injection hole 215 is sealed with a sealing member 216 after the electrolyte solution is injected. At the sealing plate 214, the positive electrode terminal 230 and the negative electrode terminal 240 are provided. In the electrical energy storage device 300, it is also possible to apply the art disclosed herein suitably.

As described above, the following items are given as specific aspects of the art disclosed herein.
Item 1: The electrical energy storage device including: the square case that includes the first surface with the substantially rectangular shape having the pair of short sides and the pair of long sides, the pair of second surfaces extending from the pair of short sides, and the pair of third surfaces extending from the pair of long sides and having a larger area than the first surface and the second surfaces; the electrode body that is accommodated inside the case and includes the positive electrode and the negative electrode; the positive electrode tab that is provided in the positive electrode; the negative electrode tab that is provided in the negative electrode; the electrolyte solution that is accommodated inside the case; and the liquid injection hole that is provided at the third surface of the case and at the position closer to the negative electrode tab than to the positive electrode tab.
Item 2: The electrical energy storage device according to Item 1, in which the positive electrode tab protrudes toward one of the second surfaces, the negative electrode tab protrudes toward the other of the second surfaces, and the liquid injection hole is provided between the other of the second surfaces and the end part of the electrode body in the direction where the negative electrode tab protrudes.
Item 3: The electrical energy storage device according to Item 1, in which both the positive electrode tab and the negative electrode tab protrude toward one of the second surfaces, and the liquid injection hole is provided between the one of the second surfaces and the end part of the electrode body in the direction where the positive electrode tab and the negative electrode tab protrude on the side opposite to the positive electrode tab with the negative electrode tab held between the liquid injection hole and the positive electrode tab.
Item 4: The electrical energy storage device according to Item 2 or 3, in which the liquid injection hole is provided over the negative electrode tab in the vertical direction.
Item 5: The electrical energy storage device according to Item 2, further including: the positive electrode terminal that is connected to the positive electrode tab and provided at the one of the second surfaces; and the negative electrode terminal that is connected to the negative electrode tab and provided at the other of the second surfaces.
Item 6: The electrical energy storage device according to any one of Items 1 to 5, in which the negative electrode tab includes the curved part that is curved from one of the third surfaces toward the other of the third surfaces, and the liquid injection hole is provided at the other of the third surfaces.
Item 7: The electrical energy storage device according to Item 6, in which the liquid injection hole directly faces the one of the third surfaces.
Item 8: The electrical energy storage device according to any one of Items 1 to 7, in which the positive electrode tab is formed of aluminum or an aluminum alloy, and the negative electrode tab is formed of copper or a copper alloy.

### REFERENCE SIGNS LIST

10 Case
12 Case main body
12a Bottom surface (first surface)
12b Long side surface (third surface)
12c Top surface
14 Sealing plate (second surface)
15 Liquid injection hole
20 Electrode body
23 Positive electrode tab
24 Negative electrode tab
24b Curved part
30 Positive electrode terminal
40 Negative electrode terminal
100 Electrical energy storage device

What is claimed is:

1. An electrical energy storage device comprising:
a square case that includes a first surface with a substantially rectangular shape having a pair of short sides and a pair of long sides, a pair of second surfaces extending from the pair of short sides, and a pair of third surfaces extending from the pair of long sides and having a larger area than the first surface and the second surfaces;
an electrode body that is accommodated inside the case and includes a positive electrode and a negative electrode;
a positive electrode tab that is provided in the positive electrode;
a negative electrode tab that is provided in the negative electrode;
an electrolyte solution that is accommodated inside the case; and
a liquid injection hole that is provided at the third surface of the case and at a position closer to the negative electrode tab than to the positive electrode tab.

2. The electrical energy storage device according to claim 1, wherein
the positive electrode tab protrudes toward one of the second surfaces,
the negative electrode tab protrudes toward the other of the second surfaces, and
the liquid injection hole is provided between the other of the second surfaces and an end part of the electrode body in a direction where the negative electrode tab protrudes.

3. The electrical energy storage device according to claim 1, wherein
both the positive electrode tab and the negative electrode tab protrude toward one of the second surfaces, and
the liquid injection hole is provided between the one of the second surfaces and an end part of the electrode body in a direction where the positive electrode tab and the negative electrode tab protrude on a side opposite to the positive electrode tab with the negative electrode tab held between the liquid injection hole and the positive electrode tab.

4. The electrical energy storage device according to claim 2, wherein the liquid injection hole is provided over the negative electrode tab in a vertical direction.

5. The electrical energy storage device according to claim 2, further comprising:
a positive electrode terminal that is connected to the positive electrode tab and provided at the one of the second surfaces; and
a negative electrode terminal that is connected to the negative electrode tab and provided at the other of the second surfaces.

6. The electrical energy storage device according to claim 1, wherein
the negative electrode tab includes a curved part that is curved from one of the third surfaces toward the other of the third surfaces, and
the liquid injection hole is provided at the other of the third surfaces.

7. The electrical energy storage device according to claim 6, wherein the liquid injection hole directly faces the one of the third surfaces.

8. The electrical energy storage device according to claim 1, wherein
the positive electrode tab is formed of aluminum or an aluminum alloy, and
the negative electrode tab is formed of copper or a copper alloy.
